(19) United States
(12) Patent Application Publication
(10) Pub. No.: US 2025/0006961 A1
(43) Pub. Date: Jan. 2, 2025

(54) ANODE SIDE WATER SEPARATION AND MANAGEMENT FOR FUEL CELL

(71) Applicant: Cummins Filtration Inc., Nashville, TN (US)

(72) Inventors: Chirag D. Parikh, Madison, WI (US); Arun P. Janakiraman, Stoughton, WI (US)

(73) Assignee: Cummins Filtration Inc., Nashville, TN (US)

(21) Appl. No.: 18/703,524

(22) PCT Filed: Oct. 24, 2022
(86) PCT No.: PCT/US2022/047560

§ 371 Date: Apr. 22, 2024

Related U.S. Application Data
(60) Provisional application No. 63/272,531, filed on Oct. 27, 2021.

(51) Int. Cl. H01M 8/04119

(52) U.S. Cl. CPC H01M 8/04164; H01M 2250/20

(57) ABSTRACT

A fuel cell system includes a fuel cell and a gas-liquid separator. The fuel cell includes an anode, a membrane, and a cathode. The gas-liquid separator includes a separator housing defining an internal cavity. The separator housing includes an inlet, an outlet, an outlet conduit, and a drain. The inlet is fluidly coupled to the fuel cell downstream from the anode. The outlet is fluidly coupled to an anode inlet of the anode. The outlet conduit extends axially into the internal cavity from a first axial end of the separator housing. The drain is disposed at a second axial end of the separator housing. The separator housing further defines an inlet passage that fluidly couples the inlet to the internal cavity and extends tangentially away form an interior surface of the separator housing.

### CROSS-REFERENCE TO RELATED PATENT APPLICATIONS

The present application is a national phase of PCT Application No. PCT/US2022/047560, filed Oct. 24, 2022, which claims the benefit of and priority to U.S. Provisional Patent Application No. 63/272,531, filed Oct. 27, 2021. The contents of these applications are hereby incorporated by reference in their entirety.

### TECHNICAL FIELD

The present disclosure generally relates to gas-liquid separation systems for fuel cells. More specifically, this disclosure relates to water separation systems for use in a recirculation loop on an anode side of a fuel cell.

### BACKGROUND

Fuel cell electric vehicles may include a fuel cell powered by hydrogen. The fuel cell generates electricity generally by using oxygen from the air and compressed hydrogen. Unlike battery systems for all-electric vehicles, which require electricity to recharge the batteries after use, the fuel cell stack is powered using hydrogen, and the amount of energy stored onboard the vehicle is determined by the size of a hydrogen fuel tank and the performance of the fuel cell system.

### SUMMARY

At least one embodiment of the present disclosure relates to a fuel cell system. The fuel cell system includes a fuel cell and a gas-liquid separator. The fuel cell includes an anode, a membrane, and a cathode. The gas-liquid separator includes a separator housing defining an internal cavity. The separator housing includes an inlet, an outlet, an outlet conduit, and a drain. The inlet is fluidly coupled to the fuel cell downstream from the anode. The outlet is fluidly coupled to an anode inlet of the anode. The outlet conduit extends axially into the internal cavity from a first axial end of the separator housing. The drain is disposed at a second axial end of the separator housing. The separator housing further defines an inlet passage that fluidly couples the inlet to the internal cavity and extends tangentially away from an interior surface of the separator housing.

Another embodiment of the present disclosure relates to a gas-liquid separator for a fuel cell system. The gas-liquid separator includes a separator housing and a drain valve. The separator housing includes a first body, a second body, and a separator plate. The first body defines a first internal cavity and an inlet passage fluidly coupled to the first internal cavity. The inlet passage is disposed proximate to a first axial end of the separator housing and extends substantially tangentially away from a surface of the first body that defines the first internal cavity. The first body includes an outlet conduit extending axially into the first internal cavity from the first axial end of the separator housing and protruding axially beyond the inlet passage. The second body is coupled to the first body and defines a second internal cavity and a drain at a second axial end of the separator housing. The separator plate is coupled to the first body and the second body. The separator plate defines a central opening that fluidly couples the first internal cavity to the second internal cavity. The drain valve is coupled to the separator housing at the drain.

Yet another embodiment of the present disclosure relates to a separator housing of a gas-liquid separator. The separator housing includes a body, an outlet conduit, and a deswirl element. The body defines an internal cavity and an inlet passage that is fluidly coupled to the internal cavity. The inlet passage extends substantially tangentially away from a surface of the body that defines the internal cavity. The outlet conduit extends axially into the internal cavity and protrudes axially beyond the inlet passage. The deswirl element is coupled to the outlet conduit and is disposed at least partially within the outlet conduit.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flow diagram of a water separation system for a fuel cell, according to an embodiment.

FIG. 2 is a perspective view of a water separator, according to an embodiment.

FIG. 3 is a side cross-sectional view of the water separator of FIG. 2.

FIG. 4 is a side cross-sectional view of a sump portion of the water separator of FIG. 2.

FIG. 5 is a partial view of a water separator, according to another embodiment.

FIG. 6 is a perspective view of a fluid profile through the water separator of FIG. 5.

FIG. 7 is a contour plot of the total pressure along a mid-plane of the water separator of FIG. 2.

FIG. 8 is a contour plot of the total pressure along a mid-plane of the water separator of FIG. 5.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to water separation systems for use in a recirculation loop on an anode side of a fuel cell. The various concepts introduced above and discussed in greater detail below may be implemented in any of numerous ways, as the described concepts are not limited to any particular manner of implementation. Examples of specific implementations and applications are provided primarily for illustrative purposes.

### Overview

Fuel cells utilize hydrogen to generate electricity, which can be used to power a motor and/or other electronic components. In some instances, excess hydrogen may be provided to the fuel cell (e.g., anode) to prevent local hydrogen starvation of the electrode(s) and to increase the life of the fuel cell. Any unused hydrogen may be recirculated and/or combined with fresh hydrogen from the fuel tank to reduce the risk of releasing unused hydrogen into the atmosphere. However, water is generated as a byproduct of the chemical reaction in the fuel cell and, as a result, the gas mixture leaving the anode may contain liquid water under pressure. The presence of water in the anode recirculation loop can reduce the efficiency of the fuel cell stack. Additionally, water droplets can accumulate in the channels of the membrane plates. Under certain conditions, the accumulated water in the membrane plates can block access of fuel to the reaction sites and/or damage the membrane assembly.

At least one embodiment of the present disclosure relates to a water separation system that is configured to separate and drain liquid water from a hydrogen gas recirculation loop for an anode side of a hydrogen fuel cell. The water separation system may include a water separator (e.g., a cyclone separator, an inertial separator device, a water separator assembly, etc.) that receives a gas mixture from the fuel cell containing water under pressure. In contrast to a filter-media-based water separator element, the water separator of the present application is configured to utilize the high tangential velocity of the gas mixture leaving the fuel cell to separate water (e.g., mist, droplets, etc.) from the gas stream. In at least one embodiment, the separator is configured to reduce pressure drop of the gas mixture, which can improve the performance of the fuel cell system by maintaining high pressure at an anode inlet. For example, the separator may include a deswirl element to recover pressure of the gas that is delivered back to the anode inlet, which can increase the operating efficiency of the fuel cell stack. The deswirl element may be positioned within an outlet conduit of the separator and/or at least partially within an interior cavity of the separator. The deswirl element may include a vane guide (e.g., a vane support element, etc.) that supports a plurality of vanes within the separator.

The geometry and arrangement of the deswirl element (vane guide and vanes) provide increase pressure drop recovery of hydrogen gas passing through the separator and enable the use of an inertial separation techniques that could otherwise negatively impact operating performance of the fuel cell.

Another embodiment of the present disclosure relates to a water separation system for a fuel cell. The water separation system includes a fuel cell, a fluid receiving manifold fluidly coupled to the fuel cell, a separator housing, a drain valve, and a water sensor. The separator housing includes an upper body defining a first internal cavity and an inlet port disposed proximate to a first axial end of the separator housing. The inlet port directs fluid from the fluid receiving manifold substantially tangentially into the first internal cavity. The upper body further includes an outlet conduit extending axially into the first internal cavity from the first axial end of the separator housing. The lower body is coupled to the upper body and defines a second internal cavity and a drain at a second axial end of the separator housing. The separator plate is disposed between the upper body and the lower body and includes a central opening that fluidly couples the first internal cavity to the second internal cavity. The drain valve is coupled to the drain. The water sensor is coupled to the lower body and is communicably coupled to the drain valve. The water sensor is configured to actuate the drain valve based on a level of water in the second internal cavity.

Still another embodiment of the present disclosure relates to a water separation system for a fuel cell that includes a fuel cell, a fluid receiving manifold fluidly coupled to the fuel cell, a separator housing, a drain valve, and a water sensor. The separator housing includes an upper body defining a first internal cavity and an inlet port that directs fluid from the fluid receiving manifold substantially tangentially into the first internal cavity. The upper body further includes an outlet conduit extending axially into the first internal cavity from a first axial end of the separator housing. The lower body is coupled to the upper body and defines a second internal cavity and a drain at a second axial end of the separator housing. The separator plate is disposed between the upper body and the lower body and includes a central opening that fluidly couples the first internal cavity to the second internal cavity.

### Example Water Separation System

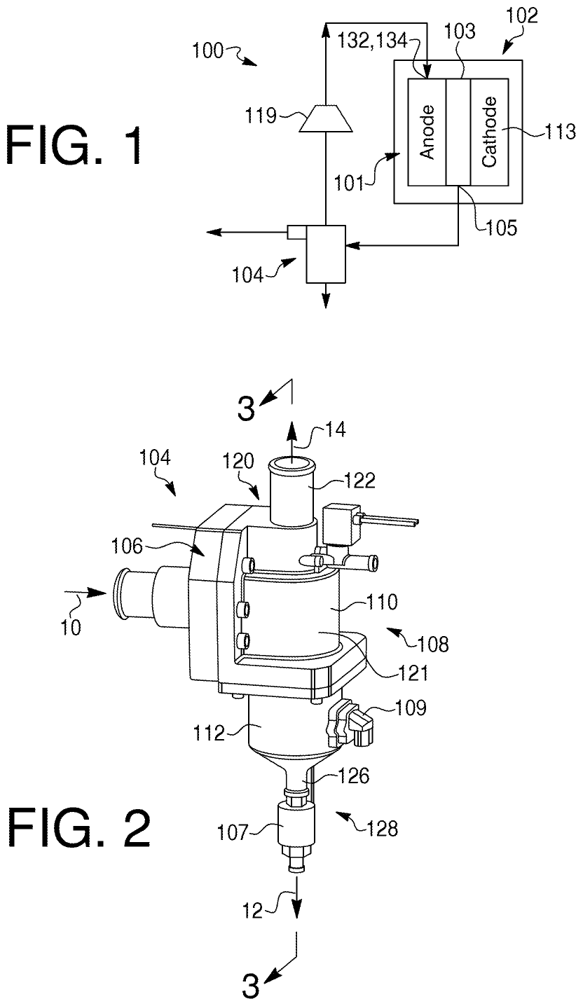

FIG. 1 shows a water separation system 100 that is designed to remove water from the gas mixture leaving the anode side 101 of a fuel cell, according to an embodiment. The water separation system 100 includes a fuel cell 102 and a gas-liquid separator, shown as separator 104 (e.g., water separator, etc.). The fuel cell 102 may be a polymer electrolyte membrane fuel cell or another fuel cell type. The fuel cell 102 may include a membrane electrode assembly including an electrolyte membrane 103 that is sandwiched or otherwise disposed between an anode 111 (e.g., negative electrode) and a cathode 113 (e.g., positive electrode). As shown in FIG. 1, the separator 104 is disposed in an anode side gas recirculation loop 115 that redirects the gas mixture leaving the anode 111 (e.g., via an anode outlet 117 of the anode 111) back into the anode 111 (e.g., via an anode inlet 134 to the anode 111). The separator 104 is designed to remove water from the gas mixture leaving the anode 111 (e.g., to separate water from unused hydrogen, etc.). An inlet 105 to the water separation system 100 may be disposed between the anode 111 and the cathode 113 (e.g., downstream of the anode 111 and electrolyte membrane 103 but upstream of the cathode 113 along a flow path of hydrogen gas through the fuel cell 102, etc.). An outlet 132 to the water separation system 100 may be fluidly coupled to the anode inlet 134 of the anode 111.

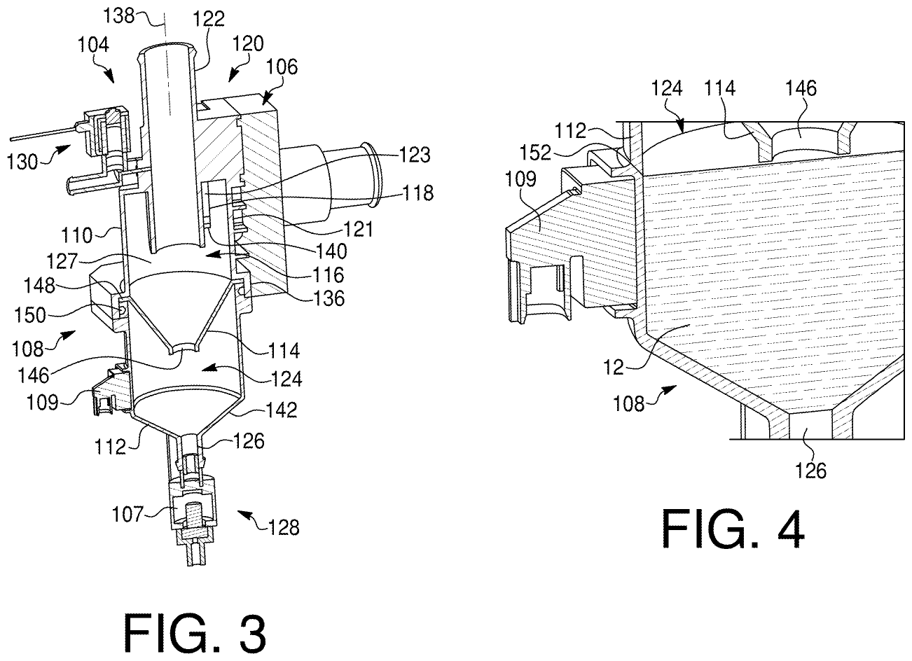

FIGS. 2 and 3 show perspective and cross-sectional views, respectively, of an example separator 104 (e.g., a cyclone separator, a water separator assembly, etc.) for use in the water separation system of FIG. 1. The separator 104 may be an inertial separator device that utilizes high fluid velocity accompanied by an abrupt change in the direction of the flow path of the incoming mixture to facilitate separation of materials having different densities. The separator 104 is designed to receive a gas-liquid mixture 10 from the anode side of the fuel cell, to separate and remove liquid 12 (e.g., water) from the gas-liquid mixture 10, and provide a substantially liquid-free gas stream 14 to an inlet side of the anode and/or other parts of the system.

As shown in FIGS. 2 and 3, the separator 104 includes a fluid receiving manifold 106 and a separator housing 108 coupled to the fluid receiving manifold 106, a purge valve 130, a drain valve 107, and a fluid sensor 109. In an embodiment, the fluid receiving manifold 106 is formed separately from the separator housing 108 and is removably coupled to the separator housing 108 via bolts or another suitable fastener. In other embodiments, the fluid receiving manifold 106 is fixedly connected to the separator housing 108 such that the fluid receiving manifold 106 cannot be separated from the separator housing 108 without cutting or damaging one of the fluid receiving manifold 106 and/or the separator housing 108.

The separator housing 108 may include first body 110 (e.g., an upper body as shown in FIGS. 2-3), a second body 112 (e.g., a lower body as shown in FIGS. 2-3) coupled to an axial end of the first body 110, and a separator plate 114 sandwiched or otherwise disposed between the first body 110 and the second body 112. In some embodiments, the second body 112 is formed separately from the first body 110 and is removably coupled to the first body 110 via bolts or another suitable fastener. In other embodiments, the second body 112 and the first body 110 are fixedly connected (e.g., welded). Among other benefits, forming the first body 110, the second body 112, and the fluid receiving manifold 106 as separate components allows for replacement of only a portion of the separator 104 in case one of the components becomes damaged. Using separate components also provides modularity and allows retrofit of different portions of the separator 104 in the event of upgrade or other design modifications.

In the embodiment of FIGS. 2 and 3, the separator 104 is an inertial separator device (e.g., a cyclone separator, etc.) that separates liquid from the gas mixture via inertia from an induced centripetal force on the gas-liquid mixture 10. The fluid receiving manifold 106 is configured to direct the gas-liquid mixture 10 into an internal cavity of the separator housing 108. As shown in FIG. 3, the fluid receiving manifold 106 is coupled to the separator housing 108 via a receiving flange 136 having a substantially planar surface. At least one of the fluid receiving manifold 106 and the receiving flange 136 may have a groove for one or more O-rings or other sealing members to sealingly engage the fluid receiving manifold 106 with the separator housing 108. In other embodiments, a separate gasket may be used to sealingly engage the fluid receiving manifold 106 to the separator housing 108. In yet other embodiments, separator housing 108 may include an inlet fluid conduit (e.g., a tube, pipe, etc.) that is configured to couple the separator housing 108 to an anode outlet independently from any other components.

As shown in FIG. 3, the first body 110 of the separator housing 108 comprises a substantially cylindrical, cup-shaped body that defines a first internal cavity 116 (e.g., an interior cavity, a hollow cavity, etc.) and an inlet port 118 (e.g., an inlet) disposed proximate to a first axial end 120 (e.g., an upper axial end as shown in FIG. 2) of the separator housing 108. The fluid receiving manifold 106 is coupled to the first body 110 and is fluidly coupled to the first internal cavity 116 via the inlet port 118. The first body includes an inlet passage 123 fluidly coupling the inlet port 118 to the first internal cavity 116. The inlet passage 123 fluidly couples the inlet port 118 to the first internal cavity 116 and directs fluid from the fluid receiving manifold 106 into the first internal cavity 116 and substantially tangentially into the first internal cavity 116 (e.g., in a direction that is substantially tangential to the outer wall(s) 121 of the separator housing 108). The inlet passage 123 extends tangentially away from a surface 127 (e.g., inner surface) of the first body 110 that defines the first internal cavity 116. The first body 110 also includes an outlet conduit 122 (e.g., vortex finder, etc.) extending axially into the first internal cavity 116 from the first axial end 120 (e.g., along a central axis 138 of the first body 110) and past a lower axial end 140 of the inlet port 118 (e.g., axially beyond the lower axial end 140 of the inlet port 118 toward the second axial end 128 of the separator housing 108). Such an arrangement facilitates inertial separation and creates an abrupt change in the flow path within the first internal cavity 116.

As shown in FIG. 3, the second body 112 is also a substantially cylindrical, cup-shaped body that defines a second internal cavity 124 that is sized similar to the first internal cavity 116. Both the first internal cavity 116 and the second internal cavity 124 are cylindrically-shaped cavities extending along the central axis 138 of the separator housing 108 such that the first internal cavity 116 and the second internal cavity 124 are axially aligned with one another. In other embodiments, the relative size and/or shape of the first internal cavity 116 and/or second internal cavity 124 may be different.

In the embodiment of FIG. 3, the second body 112 defines a drain 126 (e.g., an outlet port, a liquid outlet, etc.) at a second axial end 128 of the separator housing 108. The second body 112 also includes a lower wall 142 that tapers toward the drain 126 to direct separated liquid toward the drain 126 and out of the second body 112.

As shown in FIG. 3, the separator plate 114 may be disposed at least partially between the first body 110 and the second body 112 and is structured to direct separated liquid from the first internal cavity 116 into the second internal cavity 124 and to prevent re-entrainment of liquid into the substantially liquid-free gas stream. The separator plate 114 may comprise a conically-shaped element (e.g., a conically-shaped plate, etc.) that extends axially into the second internal cavity 124 and having an inner diameter that decreases continuously or semi-continuously (e.g., with steps, ledges, etc.) along the central axis 138 moving toward the second axial end 128. The separator plate 114 may include a circumferential flange 148 extending along a perimeter of the separator plate 114 and engaging the first body 110 and the second body 112. The circumferential flange may couple the separator plate 114 to the separator housing 108 and may be sandwiched or otherwise disposed between the first body 110 and the second body 112. The first body 110 may sealingly engage the second body 112 via a radially-facing sealing member 150 disposed between the first body 110 and the second body 112 adjacent the circumferential flange 148. The separator plate 114 defines a central opening 146, in substantially coaxial alignment with the drain 126, that fluidly couples the first internal cavity 116 to the second internal cavity 124. As shown in FIG. 3, the separator 104 also includes a purge valve 130 (e.g., solenoid valve, etc.) that is coupled to the first body 110 and is designed to bypass flow away from the recirculation loop and/or to release pressure from the system during maintenance or service. In the embodiment of FIG. 3, the purge valve is fluidly coupled to the outlet conduit 122 and is removably coupled to the first body 110. The purge valve 130 may be sealingly engaged with the first body 110 via an O-ring, gasket, or another sealing member configured to form a face seal between the purge valve 130 and the first body 110.

As shown in FIG. 3, the separator 104 also includes a drain valve 107 that is fluidly coupled to the drain 126 and designed to selectively open the drain 126 to release liquids from the second internal cavity 124. The separator 104 additionally includes a fluid sensor 109 (e.g., a water level sensor, etc.) that is designed to indicate a presence of liquid water and/or an amount of water (e.g., a level of water) within the second body 112. As shown in FIG. 4, the fluid sensor 109 is coupled to the second body 112. The fluid sensor 109 is communicably coupled to the drain valve 107 (e.g., a solenoid valve, etc.) and is designed to actuate the drain valve 107 (e.g., via a voltage signal, etc.) in response to the indication of water and/or a water level that exceeds or otherwise satisfies a threshold water level within the second internal cavity 124. This arrangement maintains fluid level below desired levels within the separator housing 108 and prevents liquid carry over to the outlet conduit 122.

In one embodiment, when the water level 152 measured or otherwise determined by the fluid sensor 109 satisfies (e.g., is equal to, greater than, etc.) a threshold water level, the fluid sensor 109 triggers the drain valve 107 to open and purge water from the separator housing 108 until the water is removed and/or falls below a low water level in the second internal cavity 124. The threshold water level may be an axial position along an inner wall of the second body 112 that is just above (e.g., axially above) the fluid sensor 109 and the low water level may be an axial position along the inner wall of the second body 112 that is just below (e.g., axially below) the fluid sensor 109. In another embodiment, the threshold water level and the low water level may be determined by two separate fluid sensors.

In other embodiments, the fluid sensor 109 triggers the drain valve 107 to open for a threshold duration (e.g., a fixed time period, etc.) instead of, or in addition to, controlling the drain valve 107 based on a low water level. In another embodiment, the fluid sensor 109 is part of a separate fluid level control system that includes a fluid level controller configured to provide control signals to the drain valve 107 in response to measurements from the fluid sensor(s) 109. In yet another embodiment, the fluid sensor 109 is communicably coupled to an engine control module (ECM) for an engine system of a vehicle instead of or in addition to the drain valve 107, and it is the ECM that controls operation of the drain valve 107 based on sensor measurements from the fluid sensor 109.

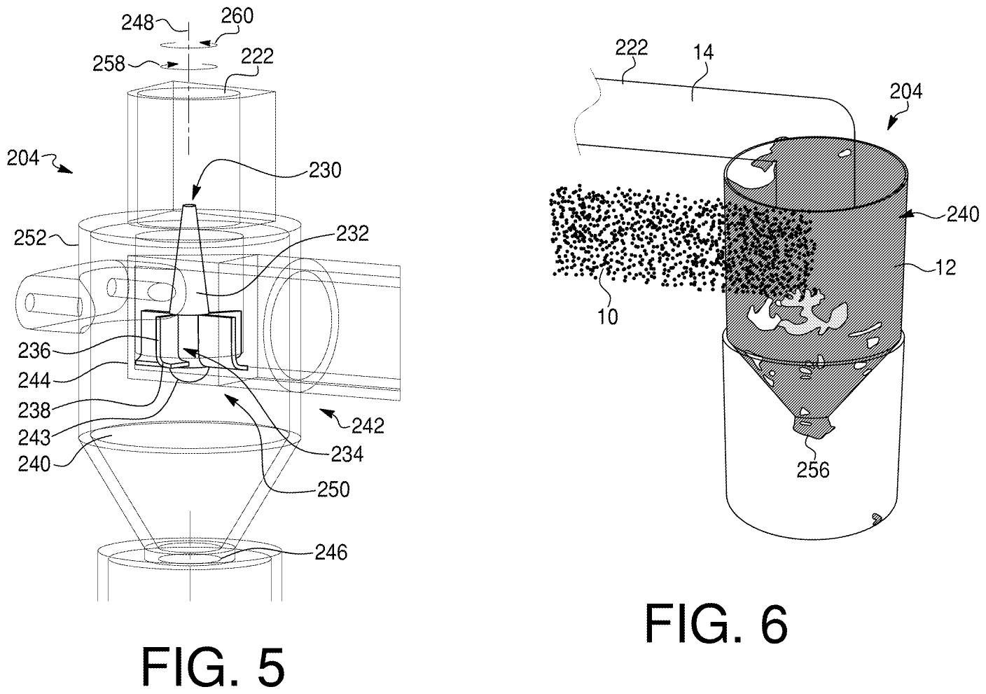

The design and arrangement of the separator 104 described with reference to FIGS. 1-4 should not be considered limiting. Many alternatives and combinations are possible without departing from the inventive concepts disclosed herein. For example, FIG. 5 shows another separator 204, according to an embodiment. The separator 204 is similar to the separator 104 of FIGS. 1-4 but also includes deswirl element 230 that is structured to recover pressure drop of fluid leaving through an outlet conduit 222 of the separator 204. As shown in FIG. 5, the deswirl element 230 is coupled to the outlet conduit 222 and disposed substantially within an inlet portion 244 of the outlet conduit 222 that extends axially into a first internal cavity 240 of a separator housing 242 (e.g., such that at least 70% of the deswirl element 230 is disposed within the inlet portion 244, or at least 80%, at least 90%, or at least 95% of the deswirl element 230 is disposed within the inlet portion 244).

The deswirl element 230 includes a vane guide 232 and a plurality of vanes 234 extending radially away from the vane guide 232, between the vane guide 232 and an inner surface of the outlet conduit 222. In an embodiment, the vane guide 232 extends across an entire axial length of the inlet portion 244 of the outlet conduit 222. In other embodiments, the vane guide 232 extends along an axial subsection of the inlet portion 244. The vane guide 232 may be supported within the inlet portion 244 by the vanes 234.

As shown in FIG. 5, the vane guide 232 may be shaped to reduce areas of low pressure within the outlet conduit 222 (e.g., areas of flow recirculation within the outlet conduit 222). For example, the vane guide 232 may include a curved surface 243 (e.g., a spherical surface, etc.) at an inlet end 250 of the inlet portion 244 and facing axially toward a drain opening 246 (e.g., drain body, etc.) of the separator housing 242. The vane guide 232 may taper along an axial direction moving axially away from the drain opening 246 and away from the inlet end 250 of the outlet conduit 222 such that an outer diameter of the vane guide 232 decreases continuously or semi-continuously moving along the axial direction through the outlet conduit 222. In other embodiments, and depending on application requirements, the geometry of the vane guide 232 may be different.

The vanes 234 may be disposed at an intermediate position along the vane guide 232 (e.g., spaced apart from opposing ends of the vane guide 232, etc.). In the embodiment of FIG. 5, the vanes 234 are disposed adjacent to a proximal end of the vane guide 232 at an inlet end 250 of the outlet conduit 222. The vanes 234 include a first vane portion 236 (e.g., an upper vane portion as shown in FIG. 5) extending in a substantially axial direction, parallel to the vane guide 232 (and a central axis of the outlet conduit 222), and a second vane portion 238 (e.g., a lower vane portion) extending at an angle from the first vane portion 236 and along a circumferential direction relative to a central axis 248 of the separator housing 242 (and the central axis of the outlet conduit 222). The second vane portions are angled to reduce the tangential component of flow velocity through the outlet conduit 222. For example, the inlet passage may be arranged to direct the gas-liquid mixture in a first circumferential direction 258 relative to the central axis 248 and the second vane portions may extend away from the first vane portions along a second circumferential direction 260 relative to the central axis 248 that is opposite to the first circumferential direction 258.

As shown in FIG. 8, in at least one embodiment, a portion of the deswirl element 230 protrudes below the inlet end 250 of the outlet conduit 222. For example, the vanes 234 of the deswirl element 230 (e.g., the second vane portions) protrude axially outward from the inlet end 250 of the outlet conduit 222 and extend into the first internal cavity 240 of the separator housing 242 (e.g., the first internal cavity of the first body 252). Beneficially, this arrangement of the deswirl element with respect to the outlet conduit 222 can improve the overall pressure recovery from the substantially liquid-free gas stream passing into the outlet conduit 222. In some embodiments the vane guide 232 also protrudes axially beyond the inlet end 250 of the outlet conduit 222 (and axially beyond the vanes 234). In yet other embodiments, only the vane guide 232 protrudes axially beyond the inlet end 250. The number, shape, and arrangement of vanes 234 and the vane guide 232 may be different in other embodiments.

FIGS. 6-8 show contour plots from a flow simulation that illustrate the performance benefits associated with incorporating the deswirl element (such as deswirl element 230) into a separator 204. As shown in FIG. 6, a gas-liquid mixture 10 entering the separator 204 includes a mist of liquid water droplets. The gas-liquid mixture 10 is directed against the inner walls of the first internal cavity 240, and the liquid 12 collects along the inner walls. The liquid 12 drains toward a first drain opening 256 of the separator housing where it can collect or drain from the separator housing (e.g., via a drain valve). The substantially liquid-free gas stream 14 moves into the outlet conduit 222 and back toward an inlet of the anode for the fuel cell system. As shown in FIG. 6, the separator 204 has a high water separation efficiency, with no remaining water droplets at an outlet to the system.

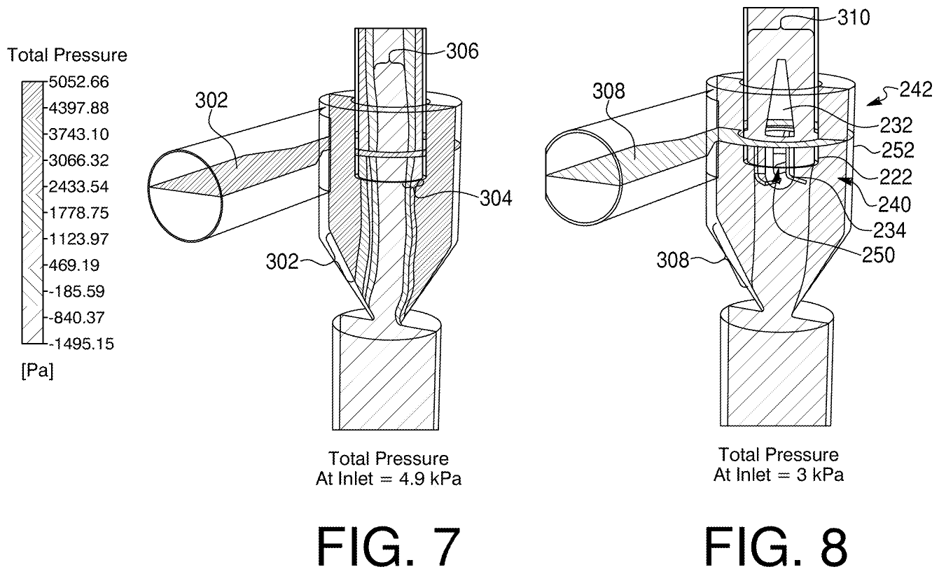

As shown in FIGS. 7 and 8, incorporating the deswirl element into the separator reduces the overall pressure drop across the separator, which can improve fuel cell (e.g., fuel stack) efficiency by reducing the pressure drop through the recirculation loop. In the example shown in FIG. 7, a first total pressure (represented by first contour 302) along an inlet region and along a radial gap between the outlet conduit and the outer wall of the upper body is within a range between approximately 3743 and 5052 Pa, a second total pressure (represented by second contours 304) along the inner surface of the outlet conduit is within a range between approximately 469 and 3500 Pa, and a third total pressure (represented by third contour 306) along a central axis within the outlet conduit is within a range between approximately −1495 and −185 Pa. In the example shown in FIG. 8, a fourth total pressure (represented by fourth contour 308) along an inlet region and along a radial gap between the outlet conduit and the outer wall of the upper body is within a range between approximately 469 and 2450 Pa, and a fifth total pressure (represented by fifth contour 310) within the outlet conduit downstream of the deswirl element is within a range between approximately −1495 and 0 Pa. Beneficially, the unique design of the separator disclosed herein is capable of removing large amounts of liquid water from the recirculation loop (e.g., coarse mist removal, having a cut size of approximately 3 micron such that any water mist having a size above approximately 3 microns is removed by the separator, etc.).

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A fuel cell system, comprising:
a fuel cell having an anode, a membrane, and a cathode; and
a gas-liquid separator having a separator housing, the separator housing defining an internal cavity, the separator housing including:
an inlet fluidly coupled to the fuel cell downstream from the anode;
an outlet fluidly coupled to an anode inlet of the anode; and
an outlet conduit extending axially into the internal cavity from a first axial end of the separator housing; and
a drain disposed at a second axial end of the separator housing, the separator housing further defining an inlet passage that fluidly couples the inlet to the internal cavity, the inlet passage extending tangentially away from an interior surface of the separator housing.

2. The fuel cell system of claim 1, wherein the inlet is arranged to receive a gas-liquid mixture from the fuel cell, and wherein the liquid separator is an inertial separator device that is configured to separate liquid from the gas-liquid mixture via an induced centripetal force to produce a substantially liquid-free gas stream at the outlet.

3. The fuel cell system of claim 1, wherein the inlet is fluidly coupled to the fuel cell at a location between the anode and the cathode.

4. The fuel cell system of claim 1, wherein the liquid separator includes a deswirl element disposed between the inlet and the outlet, the deswirl element configured to recover pressure from a substantially liquid-free gas stream leaving the liquid separator.

5. The fuel cell system of claim 1, wherein the liquid separator is part of a recirculation loop on an anode side of the fuel cell.

6. The fuel cell system of claim 5, further comprising a pump disposed in the recirculation loop and fluidly coupled to the liquid separator and the fuel cell.

7. The fuel cell system of claim 1, further comprising:
a drain valve coupled to the drain; and
a fluid sensor coupled to the separator housing and communicably coupled to the drain valve, the fluid sensor configured to actuate the drain valve based on at least one of a level of liquid in the separator housing.

8. A gas-liquid separator for a fuel cell system, comprising:
a separator housing, including:
a first body defining a first internal cavity and an inlet passage fluidly coupled to the first internal cavity, the inlet passage disposed proximate to a first axial end of the separator housing and extending substantially tangentially away from a surface of the first body that defines the first internal cavity, the first body includes an outlet conduit extending axially into the first internal cavity from the first axial end of the separator housing and protruding axially beyond the inlet passage;
a second body coupled to the first body, the second body defining a second internal cavity and a drain at a second axial end of the separator housing;
a separator plate coupled to the first body and the second body, the separator plate defining a central opening that fluidly couples the first internal cavity to the second internal cavity; and
a drain valve coupled to the separator housing at the drain.

9. The gas-liquid separator of claim 8, further comprising a fluid sensor, the fluid sensor coupled to the second body and communicably coupled to the drain valve, the fluid sensor configured to actuate the drain valve based on a level of water in the second internal cavity.

10. The gas-liquid separator of claim 8, wherein the separator plate includes a conically-shaped element that extends axially into the second internal cavity, and a circumferential flange that is sandwiched between the first body and the second body.

11. The gas-liquid separator of claim 8, further comprising a deswirl element coupled to the outlet conduit and positioned at least partially within the outlet conduit.

12. The gas-liquid separator of claim 11, wherein the deswirl element includes a vane guide and a plurality of vanes extending radially away from the vane guide, between the vane guide and an inner surface of the outlet conduit.

13. The gas-liquid separator of claim 8, further comprising a fluid receiving manifold that is removably coupled to the separator housing at the inlet passage, the fluid receiving manifold configured to direct a gas-liquid mixture from a fuel cell into the inlet passage.

14. A separator housing of a gas-liquid separator, comprising:
a body defining an internal cavity, and an inlet passage that is fluidly coupled to the internal cavity and extending substantially tangentially away from a surface of the body that defines the internal cavity;
an outlet conduit extending axially into the internal cavity and protruding axially beyond the inlet passage; and
a deswirl element coupled to the outlet conduit and disposed at least partially within the outlet conduit.

15. The separator housing of claim 14, wherein the deswirl element includes a vane guide and a plurality of vanes extending radially away from the vane guide and supporting the vane guide within the outlet conduit.

16. The separator housing of claim 15, wherein at least one of the vane guide or the plurality of vanes protrudes axially beyond an end of the outlet conduit.

17. The separator housing of claim 15, wherein the plurality of vanes is disposed at an inlet end of the outlet conduit.

18. The separator housing of claim 15, wherein at least one of the plurality of vanes includes a first vane portion extending in a substantially axial direction relative to a central axis of the outlet conduit, and a second vane portion extending at an angle from the first vane portion and at least partially along a circumferential direction relative to the central axis.

19. The separator housing of claim 18, wherein the inlet passage is arranged to direct a gas-liquid mixture in a first circumferential direction and the second vane portion extends along a second circumferential direction that is opposite to the first circumferential direction.

20. The separator housing of claim 14, wherein the deswirl element is disposed substantially within an inlet portion of the outlet conduit that extends axially into the internal cavity.
